(19) United States
(12) Patent Application Publication
(10) Pub. No.: US 2003/0128676 A1
(43) Pub. Date: Jul. 10, 2003

(54) Method of keeping-alive session and packet control function for the same

(75) Inventor: Kyung Sook Lee, Kyunggi-do (KR)

Correspondence Address: FLESHNER & KIM, LLP, P.O. Box 221200, Chantilly, VA, 20153-1200, US

(73) Assignee: LG Electronics Inc.

(21) Appl. No.: 10/331,639

(22) Filed: Dec. 31, 2002

(30) Foreign Application Priority Data
Jan. 9, 2002 (KR) P2002-1213

(51) Int. Cl. H04Q 7/00

(52) U.S. Cl. 370/328

(57) ABSTRACT

Disclosed is a method of keeping-alive a session and a packet control function for the same. According to the present invention, a packet control function, A packet control function, comprises a packet data control section for generating messages for keeping-alive of a session between a terminal and a network, and a session management section for keeping-alive the session based on the messages.

This application claims the benefit of the Korean Application No. P02-01213 filed on Jan. 9, 2002, which is hereby incorporated by reference.

### BACKGROUND OF THE INVENTION

1. Field of the Invention

The present invention relates to a mobile communication system, more particularly, to a method of keeping-alive a session and a packet control function for the same.

2. Background of the Related Art

In the existing CDMA 2000 mobile communication network, a packet control function (PCF) is located between a base station controller and a packet data serving node (PDSN) which are elements of the CDMA 2000 mobile communication network for transmitting and receiving packet data.

Especially, the PCF interworks with the base station controller and the PDSN to control packet data calls by setting up/releasing a packet data call as proposed in 3G-ISO of TIA/EIA, performs a routing of the packet data, and performs an management of a subscriber status according a possibility of a radio resource allocation.

Also, in the CDMA 2000 mobile communication network, the PCF is located between the base station controller and the PDSN, and manages a subscriber status according to the possibility of the radio resource allocation, routs packet data and transmits billing information related to radio resource to the PDSN, etc.

An inter-operability specification (IOS) that is an interface standard between nodes of the mobile communication system and defines a type of message, a message format thereof, and call control processes among the base station controller, PCF, and PDSN.

In case of applying the PCF to the 1X EV-DO system, it is required that the existing PCF interworks with the session management section each other when performing the session management function defined in IS-856 (CDMA 2000 high rate packet data air interface specification) that is a radio interface standard. According to the conventional radio interface standard, any algorithm or procedure related to such an interworking function is not described.

### SUMMARY OF THE INVENTION

An object of the present invention is directed to a session keep-alive control method that substantially obviates one or more problems due to limitations and disadvantages of the related art.

Another object of the present invention is to provide a session keep-alive control method that is suitable for performing an algorithm and procedure for efficiently managing and controlling a session by interworking a PCF with a session management section.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings

To achieve these objects and other advantages in accordance with the purpose of the invention, as embodied and broadly described herein, a packet control function, includes a packet data control section for generating messages for keeping-alive of a session between a terminal and a network, and a session management section for keeping-alive the session based on the messages.

Preferably, the packet data control section generates a message for driving a coupled timer when a resource allocated to the terminal is de-allocated.

Preferably, the session management section drives the timer based on the message for driving the coupled timer.

Preferably, the packet data control section monitors whether there is data to be transmitted to/from a terminal or to/from a packet data serving node during the driving of the timer.

Preferably, the packet data control section generates a message for stopping a coupled timer when any resource is allocated to the terminal.

Preferably, the session management section stops the timer based on the message for stopping the coupled timer.

Preferably, the session management section terminates the session after a predetermined number of requests for the keep-alive.

Preferably, the session management section stores registration information related to the session into coupled memory.

According to another aspect of the present invention, a packet control function, comprises a packet data control section for monitoring whether there is data to be transmitted to/from a terminal or to/from a packet data serving node and generating messages for keep-alive of a session between a terminal and a network according to the monitoring result, and a session management section for releasing and/or connecting the session based on the messages.

According to still another aspect of the present invention, a method of keeping-alive a session between a terminal and a network in a communication device having a packet data control section and a session management function, includes the steps of monitoring whether there is data to be transmitted to/from the terminal or to/from a packet data serving node where the terminal is in an idle mode or dormant mode, where there is no data, transmitting a message for confirming that a predetermined session is effective or not to the terminal, and where there is no response to the message, terminating the predetermined session.

According to still another aspect of the present invention, a method of keeping-alive a session between a terminal and a network in a communication device having a packet control function and a session management function, includes the steps of storing registration information related to newly established session, generating a message for stopping a timer for keep-alive of the established session, and stopping the timer based on the message.

According to still another aspect of the present invention, a method of keeping-alive a session between a terminal and a network in a communication device having a packet control function and a session management function, includes the steps of generating a first message for driving a timer for keep-alive of a predetermined session when a connection between the terminal, the network, and the communication device is released by a request of the terminal, driving the timer based on the first message and monitoring whether there is data to be transmitted to/from the terminal or to/from a packet data serving node, and adjusting the keep-alive of the predetermined session according to the monitoring result.

Preferably, it further comprises the step of monitoring whether there is data to be transmitted to/from a terminal or to/from a packet data serving node where the terminal is in an idle mode or dormant mode.

Preferably, the adjusting step further comprising the steps of where there is no data, transmitting a second message for confirming that the predetermined session is effective or not to the terminal, and where there is no response to the second message, terminating the predetermined session.

According to still another aspect of the present invention, a method of keeping-alive a session between a terminal and a network in a communication device having a packet control function and a session management function, comprises the steps of establishing a connection between the terminal, the network, and the communication device by request of a packet data serving node, generating a message for stopping a timer for keep-alive of a predetermined session after the establishing step, and stopping the timer based on the message.

Preferably, the terminal is in an idle mode or dormant mode.

According to still another aspect of the present invention, a session keep-alive control method in a mobile communication network, having a Access Terminal, an access network, a packet control function (PCF), and a packet data serving node (PDSN), for supporting a packet data service, the method comprises the steps of establishing a session between the AT and the access network, and registering information of the established session in the PCF, starting driving of a timer for a keep-alive function at the PCF, after a connection between the mobile station and the access network is established, transmitting a connection setup request message for the mobile station to the PCF at the access network, transmitting a connection setup completion message for informing completion of the requested connection setup to the access network at the PCF, stopping the driving of the timer for the keep-alive function at the PCF, and transmitting/receiving desired packet data through a connection path set between the mobile station and the PDSN.

Preferably, it further comprises the steps of when a radio resource allocated to the mobile station is de-allocated after the packet data transmitting/receiving step, starting the driving of the timer for the keep-alive function at the PCF.

Preferably, when a radio resource is allocated to the mobile terminal and the access terminal receives a packet data transmitting/receiving service after the packet data transmitting/receiving step, stopping the driving of the timer for the keep-alive function at the PCF.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating the construction of a logical device for a session keep-alive control according to a preferred embodiment of the present invention;

FIG. 2 is a diagram illustrating the keep-alive function processing procedure according to a preferred embodiment of the present invention;

FIG. 3 is a diagram illustrating the initial session setup procedure of an AT according to a preferred embodiment of the present invention;

FIG. 4 is a diagram illustrating the connection release performed by an AT and the connection re-setup procedure re-activated by the AT after the connection release according to a preferred embodiment of the present invention;

FIG. 5 is a diagram illustrating the re-activation procedure performed by a network with respect to an AT in an idle state; and

FIG. 6 is a diagram illustrating the call release procedure performed by a PDSN according to a preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A session is a logical connection for communication, and is information determined by negotiation between an access terminal (AT) and an access network (AN). The session information includes a protocol, a parameter related to the protocol, current location information of the AT.

The 1X EV-DO mobile communication network manages the session by performing a session management protocol of a session layer defined in the IS-856.

The session management protocol includes a keep-alive function, and the keep-alive function keeps the session. The present invention proposes a session management method and procedure when the PCF performs the session management function in the mobile communication network.

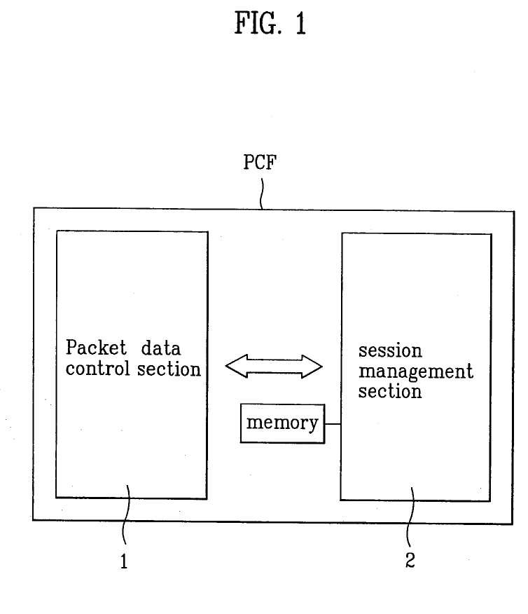

FIG. 1 is a diagram illustrating the construction of a logical device for a session keep-alive control according to a preferred embodiment of the present invention. According to the preferred embodiment of the present invention, the construction of the device for the session keep-alive control of the mobile communication network is defined as two parts. The device for the session keep-alive control may be embodied by software or hardware.

The device according to the preferred embodiment of the present invention includes a packet data control section 1 for processing a packet data call control in the mobile communication system, and a session management section 2 for processing a session management protocol in the mobile communication system.

The session management section 2 has a built-in timer. At this time, the timer may be utilized by software.

The packet data control section 1 provides a message for controlling (e.g., starting and stopping) driving of the timer for the keep-alive to the session management section 2.

Also, the packet data control section 1 transmits a message for requesting the start of the timer for the keep-alive to the session management section 2 when a radio resource allocated to the AT is de-allocated.

The packet data control section 1 also transmits a message for requesting the stop of the timer for the keep-alive to the session management section 2 when the radio resource is allocated to the AT and the packet data (transmitting/receiving) service using the allocated radio resource is provided to the AT.

Thereafter, the session management section 2 monitors the number of attempts for the keep-alive to the corresponding AT based on the received request messages, and terminates the session if the number of the attempts exceeds a predetermined number.

The session management is performed based on information (e.g., protocol, parameter, and position) determined during the negotiation between a subscriber and the mobile communication system, and the device for the session management according to a preferred embodiment of the present invention (hereinafter, referred to as PCF) as shown in FIG. 1 interworks with the base station controller of the mobile communication network, and performs a registration, keep-alive, and release of the session.

In the session management protocol defined in the IS-856, the keep-alive function is defined as a method of keeping the session of the Access Terminal (hereinafter, AT).

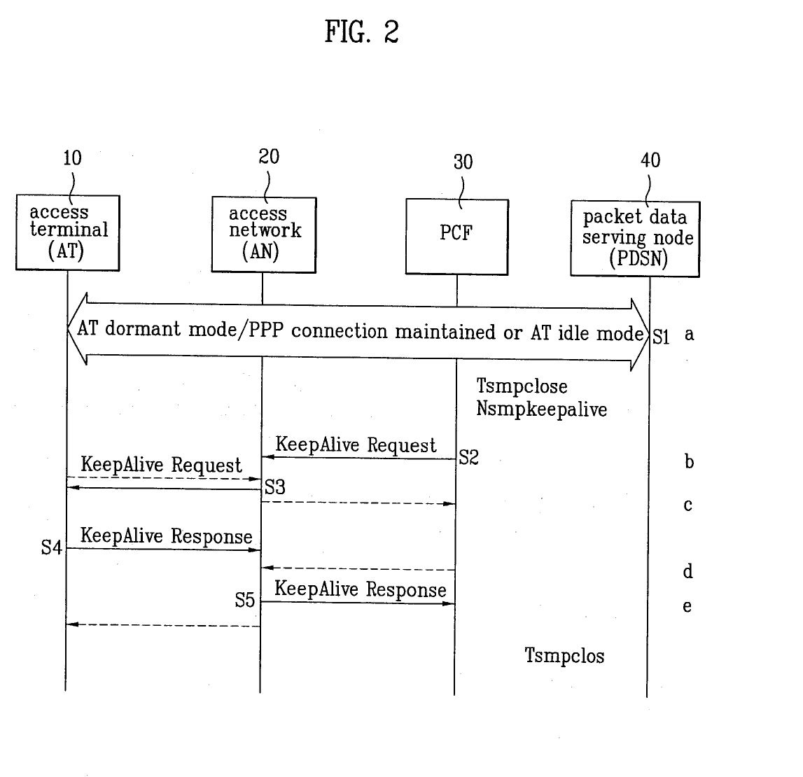

FIG. 2 is a diagram illustrating the keep-alive procedure according to a preferred embodiment of the present invention.

Referring to FIG. 2, while the session is kept, e.g., when the mobile station (AT) 10 is in an dormant mode, and a point-to-point connection between the AT 10 and PDSN 40 is kept, the PCF 30 monitors whether there is data to be transmitted to/from AT 10 or to/from PDSN 40. For another example, the AT 10 is in an idle mode (step S1), the PCF 30 monitors whether there is data to be transmitted to/from AT 10 or to/from PDSN 40. If there is no data to be transmitted for a predetermined time (e.g., T_{SMPClose}/N_{SMPKeepAlive} minutes), the PCF 30 transmits a keep-alive request message to the AT 10 through the AN 20 for confirming whether the currently kept session is effective. (steps S2 and S3).

The AT 10 transmits a keep-alive response message to the PCF 30 through the AN 20 in response to the keep-alive request message (steps S4 and S5). If the AT 10 cannot receive the data for the predetermined time T_{SMPClose}, the session management section 2 of the PCF 30 terminates the corresponding session of the AT 10 and the PCF 30.

In the present invention, messages that the session management section 2 of the PCF 30 should receive from the packet data control section 1 in order to perform the keep-alive function of the session management protocol are defined as follows.

1. A keep-alive start request message: a message that requests the driving of the timer for the keep-alive of the session management section 2.

2. A keep-alive stop request message: a message that requests the stop of driving the timer for the keep-alive of the session management section 2.

The packet data control section 1 of the PCF 30 according to the preferred embodiment of the present invention transmits the keep-alive start request message to the session management section 2 when the radio resource allocated to the AT 10 is de-allocated, and the packet data control section 1 transmits the keep-alive stop request message to the session management section 2 when the radio resource is allocated to the AT 10 and the AT 10 provides the packet data service using the allocated radio resource, so that the session management section 2 may stop driving the timer. That is, the session management section may keep the session based on the request messages from the packet data control section 1. The session management section 2 confirms the number of keep-alive attempts to the AT 10, and if the number exceeds the predetermined number N_{SMPKeepAlive}, it terminates the session.

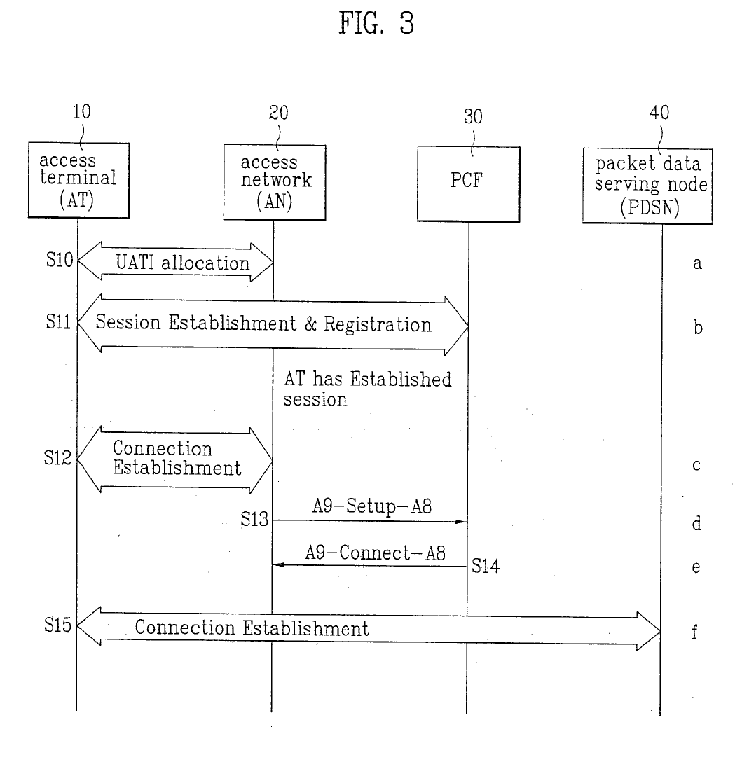

Next, with reference to FIGS. 3 to 6, the call setup and releasing procedure that includes a process of setting up an initial session and is processed by the PCF according to a preferred embodiment of the present invention will be explained.

FIG. 3 is a diagram illustrating the initial session setup procedure of the AT according to a preferred embodiment of the present invention.

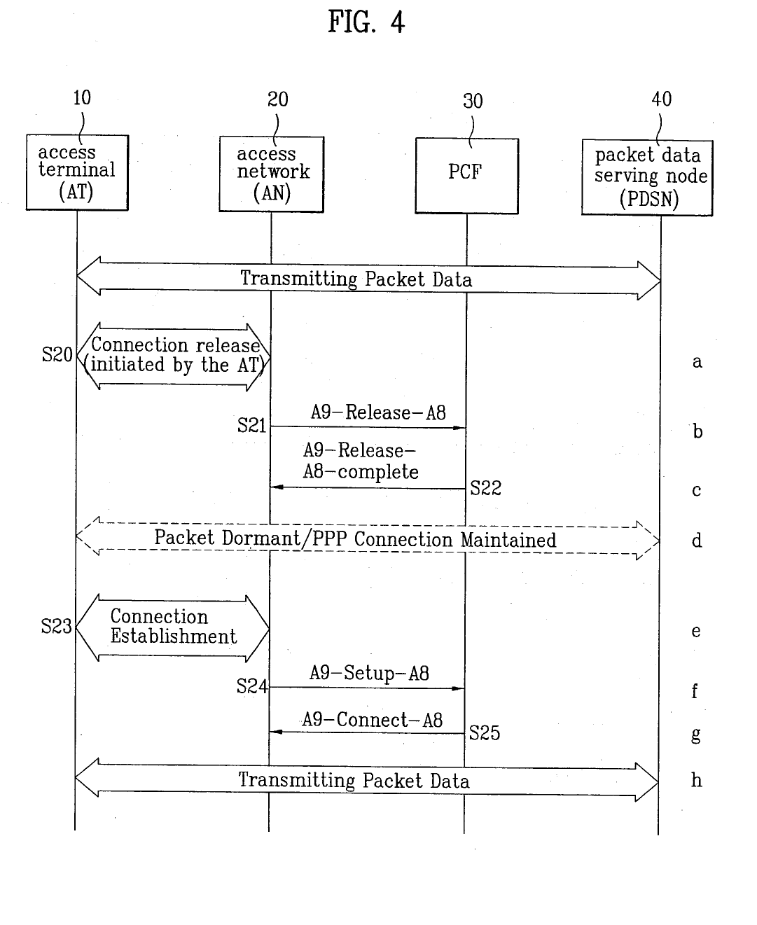

FIG. 4 is a diagram illustrating the connection release requested by the AT and the connection re-setup procedure re-activated by the AT after the connection release according the preferred embodiment of to the present invention.

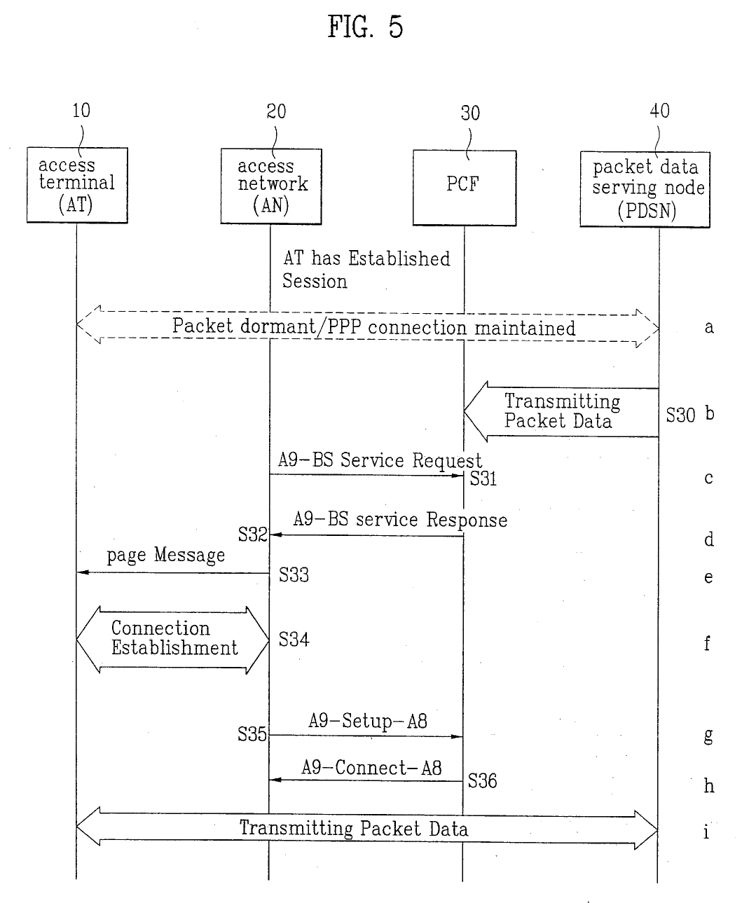

FIG. 5 is a diagram illustrating the re-activation procedure requested by the network with respect to the AT with an idle mode.

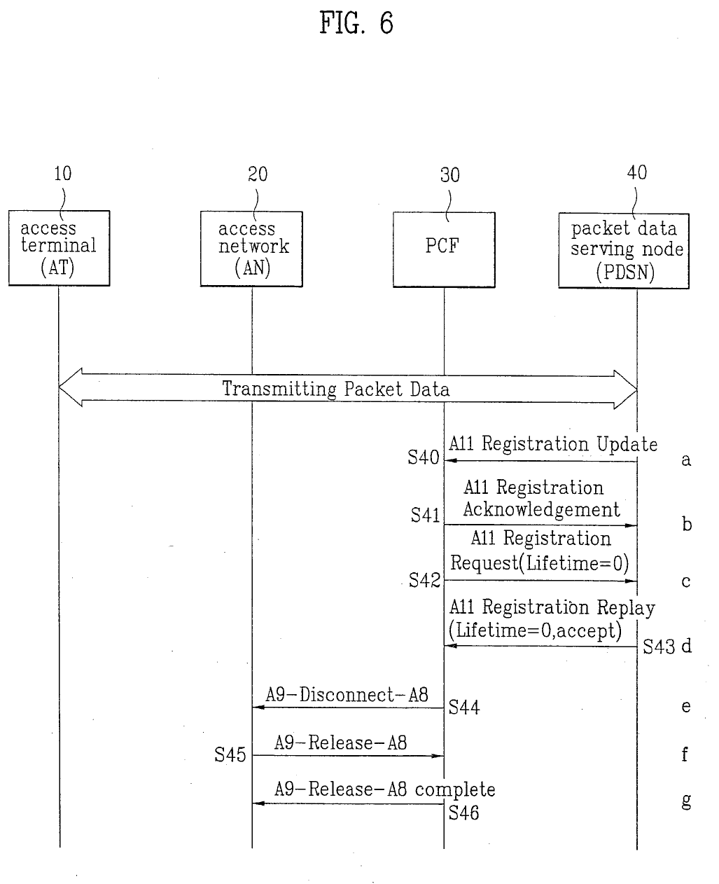

FIG. 6 is a diagram illustrating the call release procedure requested by the PDSN according a preferred embodiment of to the present invention.

Referring to FIG. 3 illustrating the initial session setup procedure of the AT according to the preferred embodiment of the present invention, the AT 10 and the access network (AN) 20 perform an allocation procedure of a unicast access terminal identifier (UATI) (step S10).

Thereafter, if there is no session, the AT 10 and the AN 20 establish the session through the session negotiation procedure, and register information of the established session in the PCF 30 (step S 11). The session management section of the PCF 30 drives the timer for the keep-alive.

The AT 10 that is ready to receive the packet data performs a connection setup procedure (step S12 to S14).

First, after the connection between the AT 10 and the AN 20 is established (step S12), the AN 20 requests a connection setup (e.g., A8 connection) by transmitting a connection setup (e.g., A9-setup-A8) request message to the PCF 30 (step S13).

The PCF 30 that completes the connection setup (e.g., A8 connection and A10 connection) transmits a connection setup (e.g., A9-connection-A8) completion message for informing the connection setup to the AN 20 (step S14). At this time, the packet data control section 1 requests the stop of the timer from the session management section 2 by transmitting the keep-alive stop request message to the session management section 2.

The AT 10 and the PDSN 40 transmit and receive the packet data through the set connection path (step S15).

FIG. 4 is a diagram illustrating the connection release requested by the AT and the connection re-setup procedure re-activated by the AT after the connection release according to preferred embodiment of the present invention.

After the completion of the transmission and reception of the packet data through the set connection path, the AT 10 releases the connection path to the AN 20 by attempting the release of the set connection (step S20).

Then, the AN 20 transmits the connection release (e.g., A9-release-A8) request message to the PCF 30. Accordingly, the PCF 30 releases the connection (e.g., A8 connection), and then transmits a connection release (e.g., A9-release-A8) completion message for informing the completion of the connection release to the AN 20 (step S22). At this time, the packet data control section 1 of the PCF 30 transmits a keep-alive start request message to the session management section 2. Then, the session management section 2 drives a timer for keep-alive of the established session and then monitors whether there is data to be transmitted to/from AT 10 or to/from PDSN 40. If there are no data to be transmitted, the steps of FIG. 2 are performed.

Thereafter, if the AT 10 sets again the connection to the AN 20 when the AT 10 is in a dormant mode and the point-to-point connection is kept between the AT and the PDSN 40 (step S23), the AN 20 requests the setup of the connection (e.g., A8 connection) by transmitting a connection setup (e.g., A9-setup-A8) request message to the PCF 30 (step S24).

The PCF 30 that completed the setup of the connection (e.g., A8 connection and A10 connection) transmits a connection setup (e.g., A9-connect-A8) completion message for informing the connection setup to the AN 20 (step S25). At this time, the packet data control section 1 requests the stop of the timer by transmitting the keep-alive stop request message to the session management section 2.

FIG. 5 is a flowchart illustrating the re-activation procedure requested by the network with respect to the AT in an idle mode.

Referring to FIG. 5, in a state that the AT 10 is in a dormant mode and the point-to-point connection is kept between the AT 10 and the PDSN 40, the PCF 30 receives the packet from the PDSN 40 through the A10 connection (step S30).

Accordingly, the PCF 30 transmits a mobile-station service (e.g., A9-BS service) request message for requesting the packet transmitting and receiving service for the AT 10 to the AN 20, and thus the AN 20 transmits a response (e.g., A9-BS service response) message to the PCF 30 (step S32).

Thereafter, the AN 20 transmits a paging message to a AT 10 (step S33). If the AT 10 that received the paging message sets the connection to the AN 20 and the connection between the AT 10 and the AN 20 is established (step S34), the AN 20 requests the setup of the connection (e.g., A8 connection) by transmitting the connection setup (e.g., A9-setup-A8) request message to the PCF 30 (step S35). The PCF 30 that completed the setup of the connection (e.g., A8 connection and A10 connection) transmits the connection setup (e.g., A9-connect-A8) completion message for informing the connection setup to the AN 20 (step S36). At this time, the packet data control section 1 requests the stop of the timer by transmitting the keep-alive stop request message to the session management section 2.

FIG. 6 is a diagram illustrating the call release procedure requested by the PDSN according to a preferred embodiment of the present invention.

Referring to FIG. 6, after the transmission and reception of the packet data through the connection path set between the AT 10 and the PDSN 40 is completed, the PDSN 40 transmits a registration (e.g., A11-registration) update message for release of the A10 connection to the PCF 30 (step S40). Accordingly, the PCF 30 transmits a registration (e.g., A11-registration) acknowledgment message (step S41) to the PDSN 40 in response to the registration update message. Also, the PCF 30 transmits a registration (e.g., A11-registration) request message for setting the life time to “0” to the PDSN 40 (step S42). The PDSN 40 transmits a registration (e.g., A11-registration) reply message in response to the registration request message (step S43). Accordingly, the connection between the PCF 30 and the PDSN 40 is released. Thereafter, the PCF 30 transmits the connection release (e.g., A9-disconnect-A8) message to the AN 20 (step S44). The AN 20 that receives the connection release message starts the release of the A8 connection by transmitting a connection release (e.g., A9-release-A8) request message to the PCF 30 (step S45). Accordingly, the PCF 30 transmits a connection release (e.g., A9-release-A8) completion message for informing the connection release to the AN 20 (step S46). At this time, the packet data control section 1 of the PCF 30 transmits the keep-alive start request message to the session management section 2. Then, the session management section 2 drives a timer for keep-alive the established session.

As described above, if the session management function defined in the IS-856 is performed by the session keep-alive control method and system according to a preferred embodiment of the present invention, a separate network element for managing the session in the 1X EV-DO mobile communication network is not required, and thus the session keep-alive control method and system according to the present invention can achieve more efficient session management using the existing PCF function.

It will be apparent to those skilled in the art than various modifications and variations can be made in the present invention. Thus, it is intended that the present invention covers the modifications and variations of this invention provided they come within the scope of the appended claims and their equivalents.

What is claimed is:

1. A packet control function, comprising:
a packet data control section for generating messages for keeping-alive of a session between a terminal and a network; and
a session management section for keeping-alive the session based on the messages.

2. The packet control function of claim 1, wherein the packet data control section generates a message for driving a coupled timer when a resource allocated to the terminal is de-allocated.

3. The packet control function of claim 2, wherein the session management section drives the timer based on the message for driving the coupled timer.

4. The packet control function of claim 3, wherein the packet data control section monitors whether there is data to be transmitted to/from a terminal or to/from a packet data serving node during the driving of the timer.

5. The packet control function of claim 5, wherein the packet data control section generates a message for stopping a coupled timer when any resource is allocated to the terminal.

6. The packet control function of claim 5, wherein the session management section stops the timer based on the message for stopping the coupled timer.

7. The packet control function of the claim 1, wherein the session management section terminates the session after a predetermined number of requests for the keep-alive.

8. The packet control function of claim 1, wherein the session management section stores registration information related to the session into coupled memory.

9. A packet control function, comprising:
a packet data control section for monitoring whether there is data to be transmitted to/from a terminal or to/from a packet data serving node and generating messages for keep-alive of a session between a terminal and a network according to the monitoring result; and
a session management section for releasing and/or connecting the session based on the messages.

10. A method of keeping-alive a session between a terminal and a network in a communication device having a packet data control section and a session management function, comprising:
monitoring whether there is data to be transmitted to/from the terminal or to/from a packet data serving node where the terminal is in an idle mode or dormant mode;
where there is no data, transmitting a message for confirming that a predetermined session is effective or not to the terminal; and
where there is no response to the message, terminating the predetermined session.

11. A method of keeping-alive a session between a terminal and a network in a communication device having a packet control function and a session management function, comprising:
storing registration information related to newly established session;
generating a message for stopping a timer for keep-alive of the established session; and
stopping the timer based on the message.

12. A method of keeping-alive a session between a terminal and a network in a communication device having a packet control function and a session management function, comprising:
generating a first message for driving a timer for keep-alive of a predetermined session when a connection between the terminal, the network, and the communication device is released by a request of the terminal;
driving the timer based on the first message and monitoring whether there is data to be transmitted to/from the terminal or to/from a packet data serving node; and
adjusting the keep-alive of the predetermined session according to the monitoring result.

13. The method of claim 12, wherein monitoring whether there is data to be transmitted to/from a terminal or to/from a packet data serving node where the terminal is in an idle mode or dormant mode.

14. The method of claim 12, the adjusting step further comprising the steps of:
where there is no data, transmitting a second message for confirming that the predetermined session is effective or not to the terminal; and
where there is no response to the second message, terminating the predetermined session.

15. A method of keeping-alive a session between a terminal and a network in a communication device having a packet control function and a session management function, comprising:
establishing a connection between the terminal, the network, and the communication device by request of a packet data serving node;
generating a message for stopping a timer for keep-alive of a predetermined session after the establishing step; and
stopping the timer based on the message.

16. The method of claim 15, wherein the terminal is in an idle mode or dormant mode.

17. A session keep-alive control method in a mobile communication network, having a Access Terminal, an access network, a packet control function (PCF), and a packet data serving node (PDSN), for supporting a packet data service, the method comprising the steps of:
establishing a session between the AT and the access network, and registering information of the established session in the PCF:
starting driving of a timer for a keep-alive function at the PCF;
after a connection between the mobile station and the access network is established, transmitting a connection setup request message for the mobile station to the PCF at the access network;
transmitting a connection setup completion message for informing completion of the requested connection setup to the access network at the PCF;
stopping the driving of the timer for the keep-alive function at the PCF; and
transmitting/receiving desired packet data through a connection path set between the mobile station and the PDSN.

18. The method of claim 17, further comprising the step of:
when a radio resource allocated to the mobile station is de-allocated after the packet data transmitting/receiving step, starting the driving of the timer for the keep-alive function at the PCF.

19. The method of claim 17, wherein when a radio resource is allocated to the mobile terminal and the access terminal receives a packet data transmitting/receiving service after the packet data transmitting/receiving step, stopping the driving of the timer for the keep-alive function at the PCF.
